(19) United States
(12) Patent Application Publication
(10) Pub. No.: US 2010/0180309 A1
(43) Pub. Date: Jul. 15, 2010

(54) METHOD AND SYSTEM FOR PROVIDING A UNICAST SERVICE IN A MOBILE DIGITAL BROADCASTING SERVICE

(75) Inventors: Jin-Woo JEON, Seongnam-si (KR); Sang-Bong Lee, Seoul (KR); Young-Jip Kim, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwoni-si (KR)

(21) Appl. No.: 12/686,126

(22) Filed: Jan. 12, 2010

(30) Foreign Application Priority Data
Jan. 12, 2009 (KR) 10-2009-0002338

(51) Int. Cl. G06F 13/00

(52) U.S. Cl. 725/54

(57) ABSTRACT

A system and method for providing a unicast service in a mobile digital broadcasting service. The method includes setting a delivery scheme and an information request scheme, which are supportable by each channel, in a specified region of an electronic service guide (ESG) data session, and receiving, by a terminal, a first data session of the ESG, and identifying information on the delivery scheme and the information request scheme, which are supportable by each channel and are set in the specified region.

### PRIORITY

This application claims priority to an application filed in the Korean Industrial Property Office on Jan. 12, 2009 and assigned Serial No. 10-2009-0002338, the content of which is incorporated herein by reference.

### BACKGROUND OF THE INVENTION

1. Field of the Invention

The present invention relates generally to mobile digital broadcasting, and more particularly to a method and system for supporting a unified service that provides both a broadcast service scheme using a broadcasting network and a unicast service scheme using a communication network in mobile digital broadcasting using Digital Video Broadcasting-Handheld (DVB-H) Convergence of Broadcast and Mobile Services (CBMS).

2. Description of the Related Art

DVB-H is a European technical standard that has been established for improving a reception rate of a terrestrial Digital Television (DTV) that is in motion. DVB-H technology can implement mobile multimedia broadcasting and provides high-quality audio and image services, even while users are driving or walking.

A service model using DVB-H includes a transmitting side that is configured with a network through which a broadcast provider and a communication provider interact with one another according to a communication network standard. The broadcast provider provides a terminal with compressed data in a delivery scheme of DVB-H on the basis of standards of DVB-Audio Visual Content (DVB-AVC). The terminal communicates with a mobile communication provider in a communication standard such as the 3G network standard, and is able to provide the broadcast provider with real time receiving-side information. In addition, the terminal can request and receive Electronic Service Guide (ESG) data through the communication network.

Most information related to broadcasting is included in the ESG in DVB-H, with which the user can select a TV or radio channel or an item to download. Also, the ESG provides information that enables the terminal to be connected with a specified Internet Protocol (IP) stream included in a DVB-H transport stream.

The entire procedure for processing the ESG is generally classified into the three processes, i.e., a first process of bootstrapping the ESG, a second process of acquiring the ESG, and a third process of updating the ESG. The first process enables a terminal to recognize the kinds of ESGs the terminal can receive and how these ESGs are obtained. The second process enables the terminal to gather the ESG information and to process the gathered ESG information. The third process enables the terminal to store the ESG information having the latest version.

FIG. 1 is a block diagram illustrating a procedure of transmitting ESG data in a multi-stream mode within a digital broadcasting service.

Referring to FIG. 1, a broadcast receiving terminal checks an IP address of an ESG Bootstrap FLUTE session from Program Specific Information/Service Information (PSI/SI) corresponding to a control signal channel in a DVB system. The ESG Bootstrap FLUTE session is used to transmit basic information of the ESG data, e.g., information on a provider of the ESG data, a list of ESG data provided by the ESG provider, etc. These pieces of information, as described above, are transmitted through an ESG provider information (i.e., an ESG Provider Discovery Descriptor) field and an ESG access information (i.e., an ESG Access Descriptor) field, respectively. Particularly, an IP address of an Announcement Carousel FLUTE session of each ESG data is transmitted through the ESG access information field.

Each piece of ESG data includes an ESG Announcement Carousel FLUTE session, which is used to provide brief information on the delivery and a configuration of the ESG data. Specifically, an ESG Mit Message field in the ESG Announcement Carousel FLUTE session is used to transmit information on a compression method of an ESG container and parameters related to the compression method, and a Partition Declaration field in the ESG Announcement Carousel FLUTE session is used to transmit parameters, such as partitioning criteria which are appointed with a time, a service ID, etc.

In addition, an Index List field, an Index Structure field, and a Multi Field Sub Index field are used to transmit structure information of the ESG data that is divided into multiple pieces of data and then transmitted. That is, the fields are used to transmit information on IP streams into which the ESG data are divided and then transmitted, a container list of the multiple pieces of ESG data carried by the respective IP streams, and a list of ESG fragments included in each container. Accordingly, by using the information as described above, the broadcast receiving terminal can recognize how the relevant ESG data is divided into multiple pieces of data, and is then transmitted, even without direct access to a session in which actual ESG data is transmitted.

The broadcast receiving terminal can receive an IP address, from which the actual ESG data is transmitted, from the Partition Declaration field, and can access a relevant ESG FLUTE session. In this case, the broadcast receiving terminal receives and decodes all ESG Fragment Containers that contain the actual ESG data, thereby completing the ESG data.

Currently, the mobile digital broadcasting market is evolving into a unified service that provides both the broadcasting network and the communication network for the sake of improving profit models and providing various services. Accordingly, it is becoming more important to complement the digital broadcasting standard so as to support the unified service.

The conventional DVB-H CBMS standard has been established based on technology for providing broadcasts in the broadcast scheme, wherein any contents about services using a unicast scheme have not been defined. Therefore, there is a problem in that, using only the current standard, it is impossible to provide a unified service, wherein both the broadcast service scheme using a broadcasting network and the unicast service scheme using a communication network can be used.

### SUMMARY OF THE INVENTION

The present invention has been made to address at least the above-mentioned problems occurring in the prior art, and provides a unified service method and system for supporting both the broadcast service scheme using a DVB-H broadcasting network and the unicast service scheme using a 3G communication network in mobile digital broadcasting using DVB-H CBMS.

In addition, the present invention provides a handover method between a mobile broadcasting service, such as DVB-H, and a unicast service utilizing a 3G communication network.

In accordance with an aspect of the present invention, there is provided a method for providing a unicast service in a mobile digital broadcasting service. The method includes setting, by a service provider, a delivery scheme and an information request scheme, which are supportable by each channel, in a specified region of an electronic service guide (ESG) data session, and receiving, by a terminal, a first data session of the ESG, and identifying information on the delivery scheme and information request scheme, which are set in the specified region. The delivery scheme includes a broadcast scheme and a unicast scheme, and the information request scheme includes a live scheme and an on-demand scheme.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a block diagram illustrating a procedure of transmitting ESG data within a digital broadcasting service;

FIG. 2 is a block diagram illustrating a digital broadcasting system for providing a unified service according to an embodiment of the present invention;

FIG. 3 is a block diagram illustrating a broadcast receiving terminal according to an embodiment of the present invention;

FIGS. 4A and 4B illustrate a standard Extensible Markup Language (XML) schema for providing a unified service according to an embodiment of the present invention;

FIG. 5 illustrates a service XML for simultaneously supporting a broadcast and a unicast upon provision of a unified service according to an embodiment of the present invention; and

FIG. 6 is a flowchart illustrating a procedure of receiving ESG data, upon provision of a unified service, according to an embodiment of the present invention.

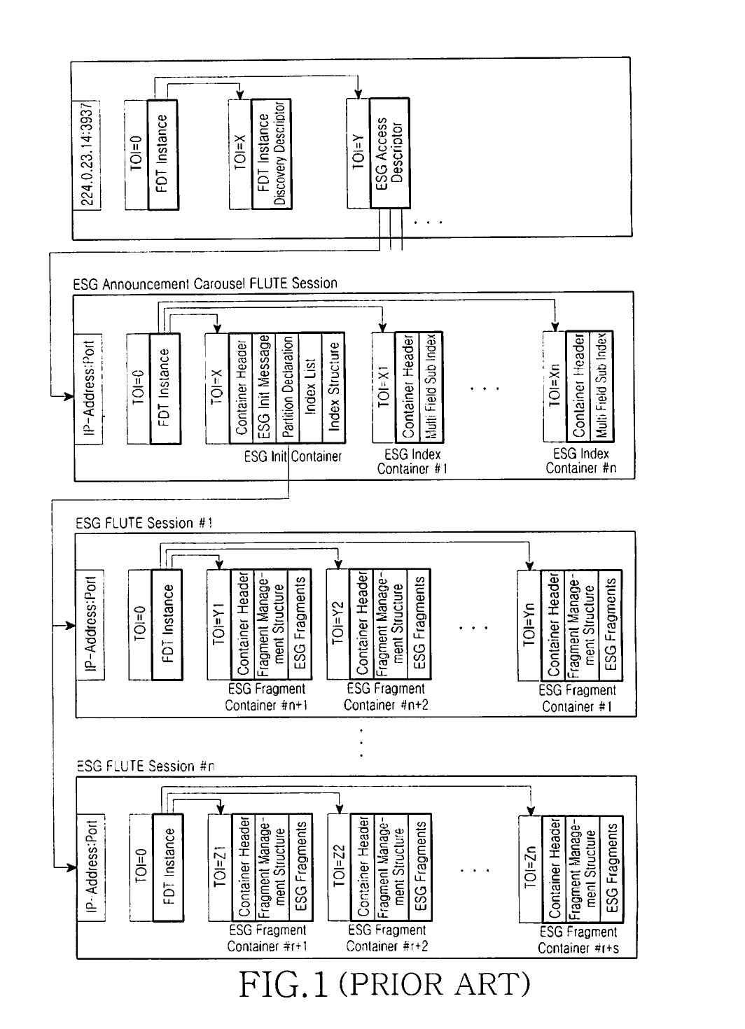

### DETAILED DESCRIPTION OF EMBODIMENTS OF THE INVENTION

Hereinafter, certain embodiments of the present invention will be described in detail with reference to the accompanying drawings. In the below description, many particular items, such as a detailed component device, are presented, but these are presented only for providing the general understanding of the present invention. It will be understood by those skilled in the art that various changes in form and detail may be made within the scope of the present invention. Further, in the following description of the present invention, detailed descriptions of known functions and configurations incorporated herein will be omitted when they may obscure the subject matter of the present invention.

Currently, DVB-H digital mobile broadcasting service based on a broadcast scheme is evolving into a unified service that uses both a broadcasting network, such as a DVB-H network, and a communication network, such as a 3G network, in order to diversify profit models. That is, the DVB-H digital mobile broadcasting service is changing to a unified service in which the broadcast service and the unicast service using a communication network, such as a 3G network, are simultaneously supported.

The present invention proposes a standard complement method for the unified service in which both the broadcast service and the unicast service can be supported, as described above.

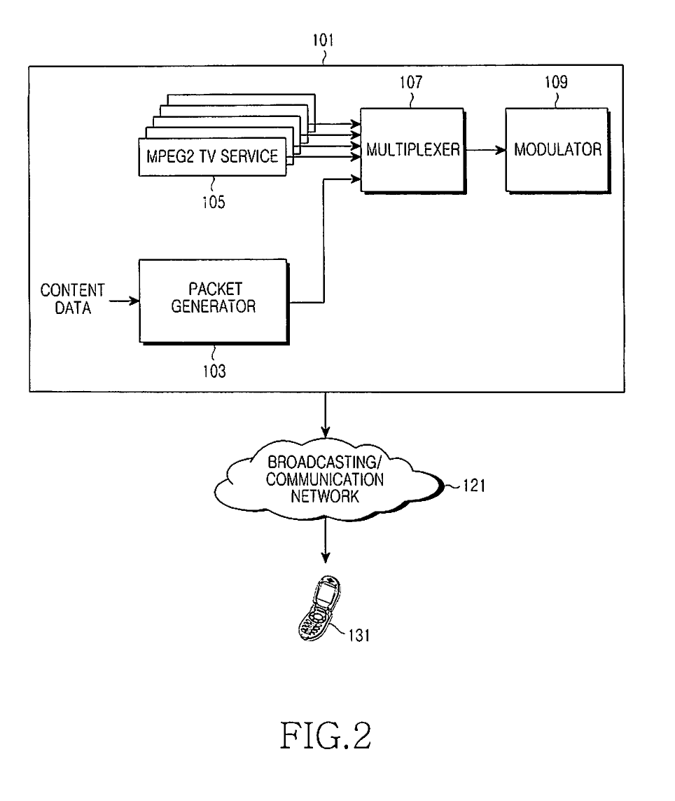

FIG. 2 is a block diagram illustrating a digital broadcasting system for providing a unified service according to an embodiment of the present invention.

Referring to FIG. 2, the digital broadcasting system includes a digital broadcasting apparatus 101 for generating a Transport Stream (TS), and broadcasting or unicasting the TS, a broadcasting/communication network 121 for transferring the TS broadcasted by the digital broadcasting apparatus 101 to a digital broadcast receiving terminal 131, and the digital broadcast receiving terminal 131 for receiving the TS broadcasted from the digital broadcasting apparatus 101, and providing a digital broadcast service through the use of the TS.

The digital broadcasting apparatus 101 transmits broadcasting data for providing a digital broadcast service to the digital broadcast receiving terminal 131. Accordingly, the digital broadcasting apparatus 101 includes a packet generator 103, a Moving Picture Experts Group 2 (MPEG2) TV service 105, a multiplexer 107, and a modulator 109. The packet generator 103 receives content data from a server to which an IP address is allocated, and packetizes the content data based on the IP address of the server, which has provided the content data. The multiplexer 107 generates a TS by using a stream of MPEG2 TV services 105 and signals of data packets input from the packet generator 103. The modulator 109 converts the TS input from the multiplexer 107 into an analog signal, amplifies the analog signal in a frequency allocated to a digital broadcast service, and transmits the amplified signal to the broadcasting/communication network 121.

The digital broadcast service represents a digital service supported in the digital broadcasting system, and can provide the user with various services, such as digital TV broadcasts, radio broadcasts, and contents (such as moving pictures, still pictures, games, etc.) provided by content providers through the use of the broadcasting/communication network 121.

The TS includes ESG-related data and content data for providing a digital broadcast service, which are separated according to sessions. Because the sessions have different IP addresses, the digital broadcast receiving terminal 131 detects the port and IP address of a desired digital broadcast service for access to a session for the desired service.

The ESG-related data represents data for receiving ESG data, and includes ESG setup data, current ESG data, and next ESG data.

According to an embodiment of the present invention, the digital broadcasting apparatus 101 sets up a service delivery scheme and an information request scheme, which can be supported by each channel, in a service fragment of an ESG data session. The service delivery scheme includes a broadcast service scheme and a unicast service scheme, and the information request scheme includes a live type information request scheme and an on-demand type information request scheme.

In addition, the ESG includes digital broadcast service guide information and digital broadcast service reception information. The digital broadcast service guide information represents information for providing guidance about current digital broadcast services. Therefore, through the digital broadcast service guide information, it is possible to select a TV channel, a radio channel, or items that can be downloaded.

Also, the digital broadcast service reception information provides access information, by which the digital broadcast receiving terminal 131 can access a specific session in a TS transmitted from the digital broadcasting apparatus 101.

The broadcasting/communication network 121 transmits a TS, broadcasted from the digital broadcasting apparatus 101, to the digital broadcast receiving terminal 131 through the broadcasting network, while transmitting a TS, unicasted from the digital broadcasting apparatus 101, to a specified digital broadcast receiving terminal 131 through the communication network.

The digital broadcast receiving terminal 131 receives a TS transmitted from the digital broadcasting apparatus 101, analyzes the received TS, and provides a digital broadcast service requested by the user.

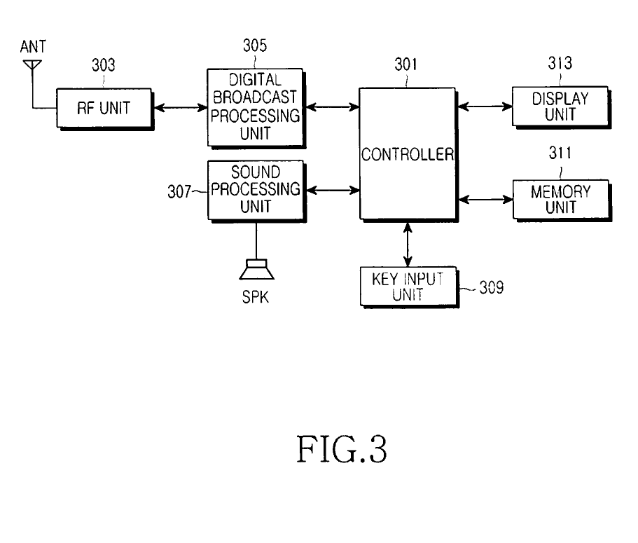

FIG. 3 is a block diagram illustrating a digital broadcast receiving terminal according to an embodiment of the present invention.

Referring to FIG. 3, a radio frequency (RF) unit 303 receives an RF signal of an ESG data stream and an RF signal of a data stream corresponding to a digital service selected by the user, which are included in a digital broadcast TS broadcasted or unicasted from the digital broadcasting apparatus 101. The RF unit 303 includes an RF receiver (not shown), which low-noise amplifies a received RF signal and down-converts the frequency of the received signal.

A digital broadcast processing unit 305 receives an RF signal input from the RF unit 303, demodulates the received RF signal to baseband digital data, and applies the digital data to a controller 301. According to an embodiment of the present invention, when the digital broadcasting system is implemented in the DVB-H broadcasting scheme, the digital broadcast processing unit 305 may be a DVB-H demodulator, which demodulates an RF signal input from the RF unit 303 in an Orthogonal Frequency Division Multiplexing (OFDM) scheme in order to extract digital broadcast data.

A sound processing unit 307 converts a voice signal output from the controller 301 into an audible sound and outputs the audible sound. A key input unit 309 includes numeric keys (including the symbol keys “*” and “#”) for viewing digital broadcasts and function keys for various functions, by generating key signals corresponding to each key pressed by the user and outputting the generated key signals to the controller 301.

A memory unit 311 stores data required for the control operation of the digital broadcast receiving terminal. According to an embodiment of the present invention, the memory unit 311 stores ESG data broadcasted from the digital broadcasting apparatus 101.

A display unit 313 displays a current state and an operational state of the digital broadcast receiving terminal according to the control of the controller 301, and generally, may be constructed with a Liquid Crystal Display (LCD) and/or Organic Light Emitting Diodes (OLED).

The controller 301 controls each component of the digital broadcast receiving terminal 131 to provide a digital broadcast service.

According to an embodiment of the present invention, the controller 301 receives an ESG Bootstrap FLUTE session, receives an ESG Announcement Carousel FLUTE session, obtains IP addresses and the number of ESG data sessions, acquires data by accessing a first ESG data session, checks a service fragment of the acquired data, and performs a control operation to display information on whether a broadcast service and/or a unicast service is supported, together with a channel list screen, through the use of information included in the service fragment.

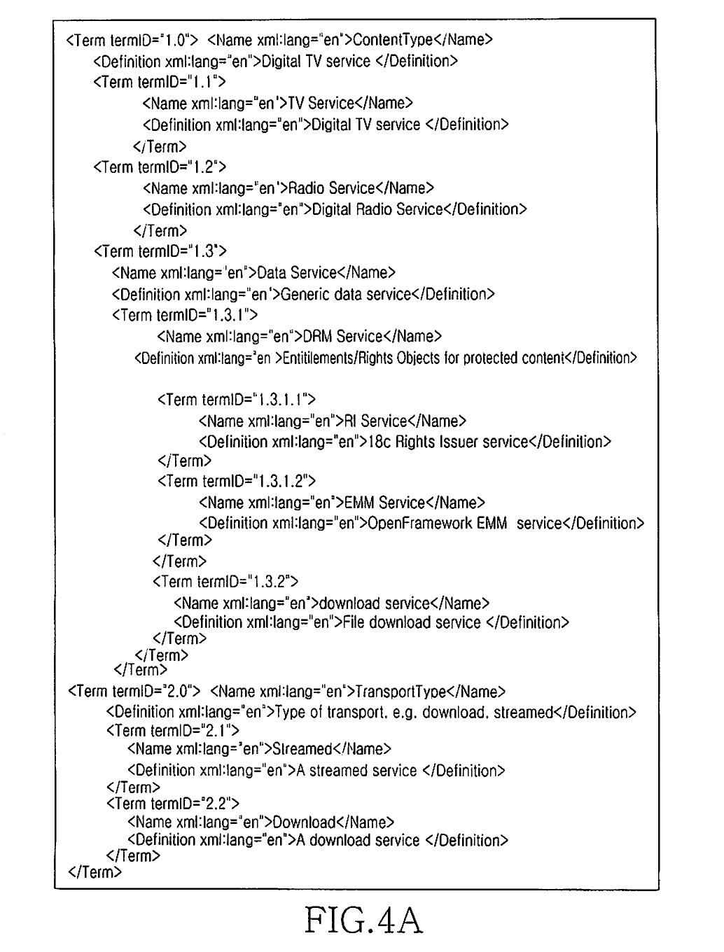

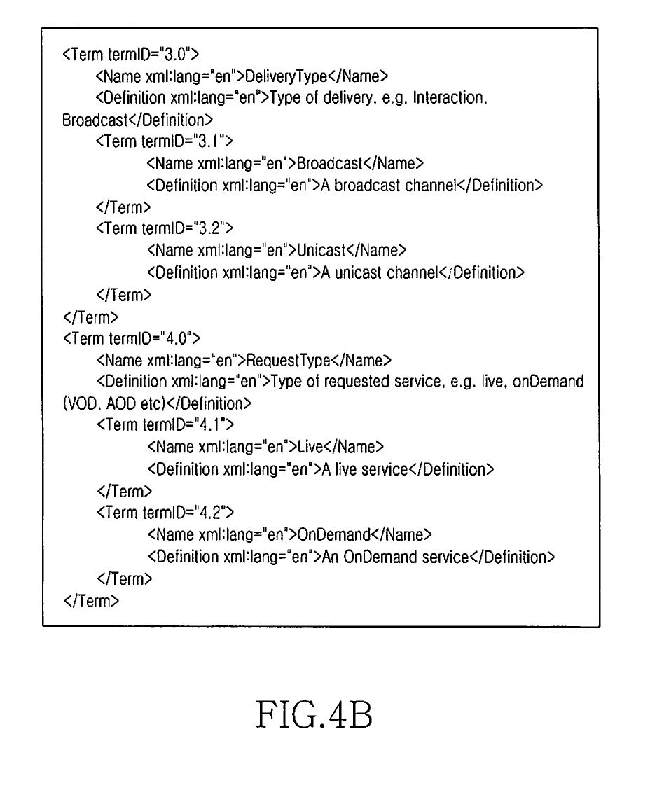

FIGS. 4A and 4B illustrate a standard Extensible Markup Language (XML) schema for providing a unified service according to an embodiment of the present invention.

The conventional CBMS ESG does not take an XML field for a heterogeneous network service into consideration.

When receiving ESG data, a digital broadcast receiving terminal receives and decodes all ESG fragment containers in which actual ESG data is contained, thereby completing one ESG data. Fragments included in the fragment containers are classified into several types. Of the types of fragments, a service fragment is used for construction of a channel list, and is included mainly in a first-received ESG session. The XML schema of the conventional service fragment does not include a method for distinguishing between a broadcast channel through a DVB-H broadcasting network and a unicast channel through a communication network, such as a 3G. Therefore, a need exists for a complement to the standard XML specification, in order to provide a unified service which supports a service including a heterogeneous network service, as illustrated in FIGS. 4A and 4B.

FIG. 4A illustrates contents defined as the conventional CBMS ESG standard, and FIG. 4B illustrates a part newly defined according to the characteristics of the present invention.

According to an embodiment of the present invention, “DeliveryType” and “RequestType” are additionally defined in a “Type” which has been defined in an “Annex C Default Classification Schemes” portion of a CBMS ESG standard “tm3348r2.cbms1199r14.IPDC_Electronic_Service_Guide.doc,” as illustrated in FIG. 4B, based on the characteristics of the present invention.

Because the service fragment represents a unified channel in the unified service, “DeliveryType” is defined in “termID 3.0” according to the characteristics of the present invention. In addition, in order to define service types for a broadcast channel of a DVB-H network and a unicast channel of a 3G network with “termID 3.1” and “termID 3.2,” respectively, “Broadcast” is defined in the “termID 3.1” and “Unicast” is defined in the “termID 3.2”.

For a service supporting both the networks, two service types are defined. Also, when there is no appointed network, a basic delivery scheme is set to be used. Either the broadcast scheme or the unicast scheme may be set to be the basic delivery scheme.

When the broadcast and unicast services are simultaneously supported in one service or channel, whether both the delivery schemes are to be displayed or only one preferable network is to be displayed in a channel list may be selected through environment setup by the user.

Also, in order to set a default channel type in the service fragment, a default attribute value is defined in the service type, and is then used. In this case, it is possible to directly determine whether a relevant channel provides any service of broadcast and unicast as a basic service. The basic channel type may be set to be a first-defined type of the two types.

Also, in the case of a unicast service, a live service and an on-demand service, such as Video On Demand/Audio On Demand (VOD/AOD), are available. In order to distinguish between such service schemes, “termID 4.1” and “termID 4.2” are additionally defined. In this case, the live service is set as a basic value.

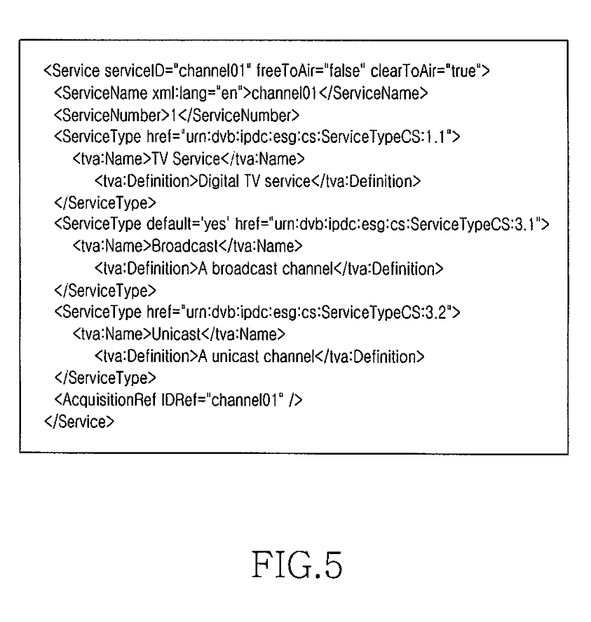

FIG. 5 illustrates a service XML for simultaneously supporting a broadcast and a unicast, upon provision of a unified service, according to an embodiment of the present invention.

Referring to FIG. 5, “ContentType” is “TV service,” and “DeliveryType” shows that both “broadcast” and “unicast” can be supported. Also, a “default” attribute is defined, and “DeliveryType” set to “default=yes” is established as a default type.

In this case, first, a basic reproduction scheme is performed based on a default delivery scheme, and secondly, a delivery is attempted according to “Delivery Type”, when a signal of the default delivery type is weak or when a service provision becomes impossible. When the “Delivery Type” is “Broadcast only,” the corresponding channel does not support another scheme, so that it is unnecessary to attempt a delivery in another scheme. When there is no “Default” attribute, the terminal can determine a basic default attribute to be a type first-defined in service XML.

Upon providing a unified service according to an embodiment of the present invention, when a digital broadcast receiving terminal receives ESG data, the digital broadcast receiving terminal accesses a first ESG data session, receives a service fragment, and analyzes the received service fragment in order to display a delivery type supported by a channel, upon displaying a channel list on a screen. In addition, when the terminal implements an application, channel display can be done to enable the user to easily recognize a delivery scheme in such a manner as to display only channels supporting only a broadcast service, to display only channels supporting only a unicast service, or to display only channels supporting both a broadcast service and a unicast service according to the setting of the user.

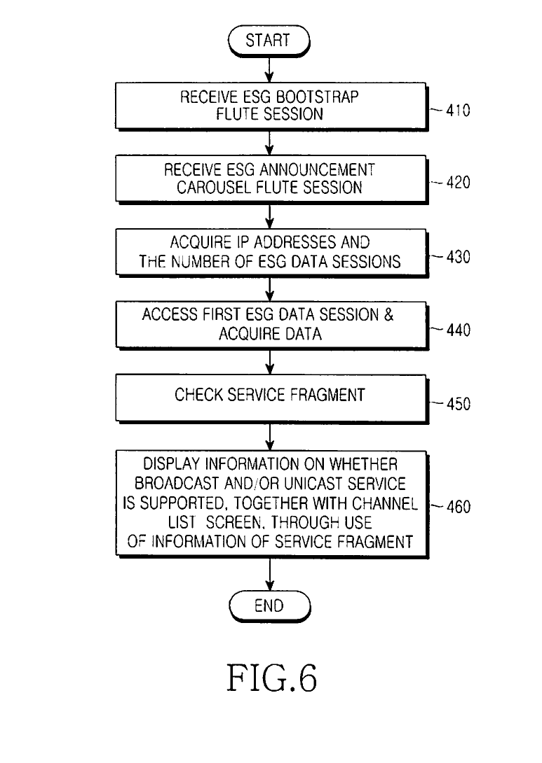

FIG. 6 is a flowchart illustrating a procedure of receiving ESG data, upon provision of a unified service, according to an embodiment of the present invention.

Referring to FIG. 6, a terminal receives an ESG Bootstrap FLUTE session in step 410. In step 420, the terminal receives an ESG Announcement Carousel FLUTE session. In step 430, the terminal obtains IP addresses and the number of ESG data sessions. In step 440, the terminal accesses a first ESG data session, and acquires data. In step 450, the terminal checks a service fragment of the acquired data, and receives the remaining data using a background service. In step 460, the terminal displays information on whether a broadcast service and/or a unicast service are supported, together with a channel list screen, through the use of information included in the service fragment.

As described above, upon provision of a unified service, when a broadcast receiving terminal receives ESG data, the broadcast receiving terminal accesses only a first ESG data session and receives a service fragment above all. Thereafter, the broadcast receiving terminal can display a delivery type supported by a corresponding channel when analyzing the received service fragment and displaying a channel list on a screen, and receives the remaining data using a background service, such that the broadcast receiving terminal can quickly execute a mobile broadcast application.

Upon provision of a unified service according to an embodiment of the present invention, when an application of the terminal is implemented, a setting can be made according to a set “Request Type” in such a manner that a corresponding content fragment expresses a broadcast schedule when the “Request Type” is set to “Live,” and that a corresponding content fragment expresses a reproduction list when the “Request Type” is set to “OnDemand.”

Also, in a unified service according to an embodiment of the present invention, because different delivery types are supported according to channels, an application of a receiving terminal must rapidly identify delivery types supported by each corresponding channel. In this case, according to the present invention, because checking “Delivery Type” defined in a service segment is sufficient for identifying a delivery type supported by a corresponding channel, it is possible to directly select a player suitable to the supported delivery type. In addition, when it is impossible to provide a service of a specific delivery type, whether or not to attempt a reproduction using another delivery type as a substitute for the specific delivery type can be rapidly determined by checking only the “Delivery Type.”

According to above described embodiments of the present invention, it is possible to provide a unified service that supports both the broadcast scheme using a DVB-H broadcasting network and the unicast scheme using a 3G communication network in mobile digital broadcasting using DVB-H CBMS.

In addition, when the service fragment of the CBMS standard is enhanced as described in the embodiments of the present invention, it is possible to more efficiently and rapidly distinguish between a broadcast service and a unicast service.

Also, differently from the conventional other schemes, the method of the present invention enables the identification of whether or not a unicast and/or a broadcast is supported with just service information, even without additional checking of other information. Accordingly, when the terminal supports a seamless handover, it is possible to determine in advance whether or not a seamless handover is attempted, even without an additional search for Access/Acquisition information.

In addition, although a receiving terminal receives only one service fragment, it is possible to display delivery types supported by each channel directly on a screen, even without additionally receiving other information, when displaying a channel list for a unified service, and the user identifies a delivery scheme and can more quickly select a broadcast desired by himself/herself. Accordingly, there is an effect of enhancing the operational efficiencies and speeds of applications.

While the present invention has been shown and described with reference to certain embodiments thereof, it will be understood by those skilled in the art that various changes in form and details may be made therein without departing from the spirit and scope of the invention as defined by the appended claims.

What is claimed is:

1. A method for providing a unicast service in a mobile digital broadcasting service, the method comprising the steps of:
setting, by a digital broadcasting apparatus, a delivery scheme and an information request scheme, which are supportable by each channel, in a specified region of an Electronic Service Guide (ESG) data session;
receiving, by a service receiving terminal, a first data session of the ESG; and
identifying, by the service receiving terminal, information on the delivery scheme and the information request scheme, which are set in the specified region.

2. The method of claim 1, wherein the delivery scheme includes a broadcast scheme and a unicast scheme.

3. The method of claim 2, further comprising displaying either a channel supporting only the broadcast scheme or only the unicast scheme, or a channel supporting both the broadcast and unicast schemes, based on the identified delivery scheme of each channel.

4. The method of claim 1, wherein the information request scheme includes a live scheme and an on-demand scheme.

5. The method of claim 1, wherein the specified region of the ESG data session corresponds to a service fragment of the ESG data session.

6. The method of claim 1, wherein setting the delivery scheme comprises setting a basic delivery scheme from among supportable delivery schemes.

7. The method of claim 6, further comprising:
selecting, by the terminal, a channel; and
setting a first delivery scheme to the basic delivery scheme set in the selected channel.

8. The method of claim 1, wherein setting the information request scheme comprises setting a basic request scheme from among supportable information request schemes

9. The method of claim 8, further comprising:
selecting, by the terminal, a channel; and
setting a first request scheme to the basic request scheme set in the selected channel.

10. The method of claim 1, further comprising displaying, by the terminal, a channel list and the identified information on the delivery scheme and the information request scheme of each channel.

11. A system for providing a unicast service in a mobile digital broadcasting service, the system comprising:
a digital broadcasting apparatus for setting a delivery scheme and an information request scheme, which are supportable by each channel, in a specified region of an Electronic Service Guide (ESG) data session; and
a broadcast receiving terminal for receiving a first data session of the ESG, and identifying information on the delivery scheme and the information request scheme, which are set in the specified region.

12. The system of claim 11, wherein the delivery scheme comprises:
a broadcast scheme; and
a unicast scheme.

13. The system of claim 12, wherein the broadcast receiving terminal displays either a channel supporting only the broadcast scheme or only the unicast scheme, or a channel supporting both the broadcast and unicast schemes, based on the identified delivery scheme of each channel.

14. The system of claim 11, wherein the information request scheme comprises:
a live scheme; and
an on-demand scheme.

15. The system of claim 11, wherein the specified region of the ESG data session corresponds to a service fragment of the ESG data session.

16. The system of claim 11, wherein the digital broadcasting apparatus sets a basic delivery scheme from among supportable delivery schemes.

17. The system of claim 16, wherein, when the broadcast receiving terminal selects a channel, and sets a first delivery scheme to the basic delivery scheme set in the selected channel.

18. The system of claim 11, wherein the digital broadcasting apparatus sets a basic request scheme from among supportable information request schemes.

19. The system of claim 18, wherein, when the broadcast receiving terminal selects a channel, and sets a first request scheme to the basic request scheme set in the selected channel.

20. The system of claim 11, wherein the broadcast receiving terminal comprises:
a controller for displaying a channel list and the identified information on the delivery scheme and the information request scheme of each channel.
